(19) United States
(12) Patent Application Publication
(10) Pub. No.: US 2010/0329657 A1
(43) Pub. Date: Dec. 30, 2010

(54) Method and Apparatus for Imaging a Moving Object

(75) Inventors: Kazukuni Hosoi, Saitama Pref. (JP); Tohru Takahashi, Saitama (JP); Ken Fukuba, Saitama Pref. (JP); Tokuma Yamazaki, Saitama Pref. (JP); Takashi Sampei, Saitama Pref. (JP); Satoshi Komi, Saitama Pref. (JP); Nobuhiro Ebara, Gunma Pref. (JP)

Correspondence Address: Kaplan Gilman & Pergament LLP, 1480 Route 9 North, Woodbridge, NJ, 07095, US

(73) Assignees: Optoelectronics Co., Ltd., Warabi, Saitama Pref. (JP); Opticon, Inc., Orangeburg, NY (US)

(21) Appl. No.: 12/596,528

(22) PCT Filed: Apr. 18, 2007
(86) PCT No.: PCT/US07/09421

§ 371 Date: Jul. 14, 2010

(51) Int. Cl. G03B 9/08; G03B 9/70; H04N 5/222

(52) U.S. Cl. 396/169; 396/180; 348/371

(57) ABSTRACT

A relatively rapidly moving object is imaged with a sensor incorporating a rolling electronic shutter, while using flash illumination which is comparable to or dimmer than ambient light. This is achieved by utilizing a physical shutter between the object and sensor which is synchronized to the flash. Preferably, the physical shutter is also operated so as to be open for a time interval which is coextensive with the presence of the flash. Preferably, an optical mechanism is provided between the object and sensor which causes the image to be focused when the light is flashed and blurred otherwise. Preferably, an optical filter is positioned between the object and sensor, and this filter is constructed to transmit to the CMOS sensor light at the wavelength of the flashing light source but to attenuate ambient light.

### BACKGROUND OF THE INVENTION

The present invention relates generally to the generation of an electronic image and, more particularly, concerns the generation of an image of a moving object, making use of a rolling shutter.

Two well-known types of electronic image sensors are CMOS sensors and charge-coupled devices (CCDs). CMOS sensors, generally, represent the lower cost option and have a number of other advantages. For example, CMOS fabrication technologies lend themselves to the inclusion of timing circuits, analog-to-digital converters, and other functional blocks within an area of the image sensor. CCD sensors, on the other hand, must be accompanied by separate circuits that provide those functions.

CCD sensors have the advantage that they incorporate an electronic shutter mechanism known as a global shutter. In imagers of this type, the entire device is reset before integration (collection of light) to remove any residual signal in the sensor wells (pixel defining elements) of an imager. The pixels then accumulate charge for a predefined integration period, with light collection starting and ending simultaneously for all pixels. At the end of the integration period, all charges are transferred simultaneously to light shielded areas of the sensor to prevent further accumulation of charge during the readout process. The charges are then shifted out of the light shielded areas of the sensor and read out. As a result, with a global shutter sensor, an image of a moving object is “frozen” in time, provided that the integration time is short enough to avoid motion blur. It is known that, with a global shutter, motion blur can be reduced or avoided by using a short duration flash of illumination, as when a flash photograph is taken.

CMOS image sensors use a rolling shutter, which operates differently, in that the photodiodes (pixels) do not collect light at the same time. Al pixels in one row of the imager collect tight during exactly the same period of time, but the time light collection starts and ends is slightly different for each row, the top row of the imager being the first one to start collecting the light and the first one to finish collecting. The start and end of the light collection for following rows is slightly, although increasingly, delayed. The total light collection time for each row may be exactly the same; and the delay between rows may be constant. The time delay between a row being reset and a row being read is the integration time. By varying the amount of time between when the reset sweeps past a row and when the readout of the row takes place, the integration time can be controlled, Since the integration process moves through the image over some length of time, some motion blur may be apparent, even with a relatively slow moving object. Some reduction in motion blur may be achieved with flashed illumination, but a very bright flash is necessary to permit sufficient light to be collected by the last row of the imager, but the increased expense of a bright flasher and the wasteful energy consumption are undesirable.

One type of imaging apparatus which often utilizes a CMOS imager is a barcode reader, Scanning barcodes on objects on a moving conveyor belt can represent a particularly challenging task. Not only are the barcodes relatively small, but the code elements are very closely spaced. The barcode must be imaged accurately for proper decoding, and image blur can impede that process. Even a relatively slowly moving barcode may therefore be the equivalent of a rapidly moving object, from the point of view of the quality of the image to be formed. It will be appreciated that the difficulty with barcodes is substantially increased when a two-dimensional barcode is utilized. It would be desirable to be able to image a moving barcode without resorting to the use of intense flashing light.

### SUMMARY OF THE INVENTION

In accordance with the present invention, a relatively rapidly moving object may be imaged with a sensor incorporating a rolling electronic shutter, while using flash illumination which is comparable to or dimmer than ambient light. This is achieved by utilizing a physical shutter between the object and sensor which is synchronized to the flash. Preferably, the physical shutter is also operated so as to be open for a time interval which is coextensive with the presence of the flash.

In a preferred embodiment, an optical mechanism may is the provided between the object and sensor which causes the image to be focused when the light is flashed and blurred otherwise.

In a preferred embodiment, an optical filter is positioned between the object and sensor, and this filter is constructed to transmit to the CMOS sensor light at the wavelength of the flashing light source but to attenuate ambient light.

During the time that the shutter is open, the ambient light and flashing light source combine to provide sufficient power for imaging. However, because the ambient light is being used in combination with the flashing source, the exposure time can be minimized. Hence, distortion and blur are minimized by having a small exposure time, but ambient light and a flashing light source combine to make the incident power enough to image the desired object.

### BRIEF DESCRIPTION OF THE DRAWINGS

The foregoing brief description and further objects, features, and advantages of the present invention will be understood more completely from the following detailed description of presently preferred, but nonetheless illustrative, embodiments in accordance with the present invention, with reference being had to the accompanying drawings in which:

FIGS. 1(A) and 1(B) are timing charts illustrating the operation of a CMOS (rolling shutter) and a CCD (global shutter) imager, respectively;

FIGS. 2(A) and 2(B) are timing charts illustrating the operation of a CMOS (rolling shutter) and a CCD (global shutter) imager, respectively, with flash illumination;

FIG. 3 is a timing chart illustrating the operation of a CMOS (rolling shutter) imager with the addition of a physical shutter;

FIG. 4 is a functional block diagram illustrating a first embodiment 30 of an imaging system embodying the present invention;

FIG. 5 is a functional block diagram illustrating a second embodiment 30′ of an imaging system embodying the present invention; and

FIG. 6 is a functional block diagram illustrating a third embodiment 30″ of an imaging system embodying the present invention.

### DETAILED DESCRIPTION OF THE PREFERRED EMBODIMENTS

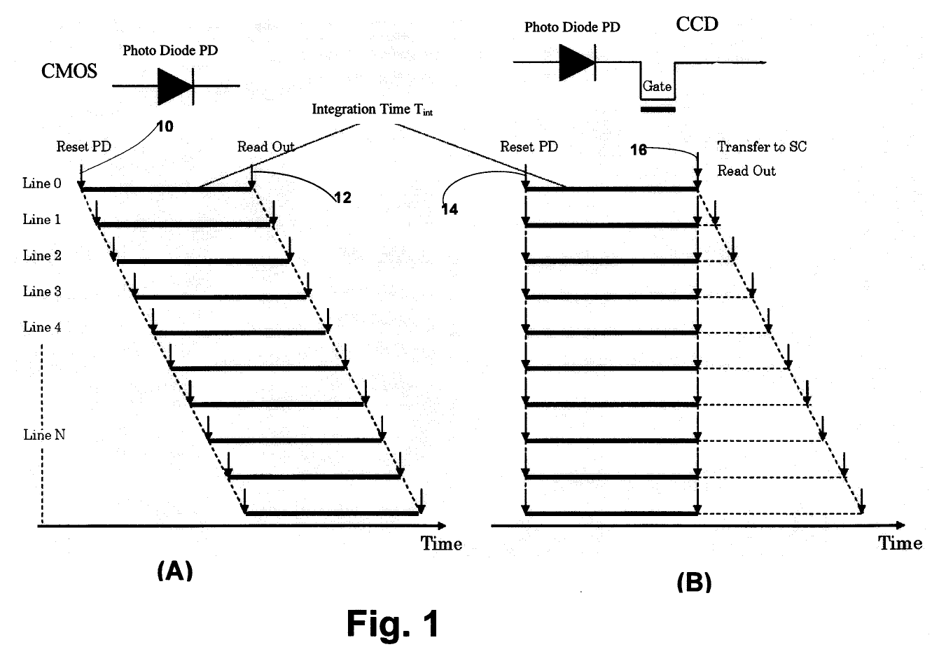

Turning now to the drawings, FIGS. 1(A) and 1(B) are timing charts illustrating the operation of a CMOS (rolling shutter) and a CCD (global shutter) imager, respectively. In each case, the imager has N lines, each containing a plurality of sensors. A CMOS sensor is represented simply as photodiodes PD, and a CCD sensor as a photodiode PD. In the CCD imager of FIG. 1(B), the sensors are allowed to accept light energy, after being reset at 14, for an integration time Tᵢₙₜ, at the conclusion of which all gates are enabled simultaneously at 16, causing all the cells of the imager to be read out at the same time. Thus, every line stops accepting light at precisely the same instant, which has a stop action effect.

In contrast, in the CMOS imager of FIG. 1(A), the cells of line 0 begin receiving light energy at 10, and the entire line is read out at 12, after integration time Tᵢₙₜ. Similarly, each of the subsequent lines experiences an integration time Tᵢₙₜ, but it does not start receiving light until a delay after the preceding line starts. With a stationary object, this does not make a difference, but with an object that is moving with sufficient speed, each line is captured after the object has experienced a certain amount of movement since the previous line. As a result, the CMOS imager exhibits a trapezoidal distortion, and image blur.

That is, an upright rectangular object takes on a trapezoidal shape tilt shape, making it seem to tilt away from the direction of movement, because the object has moved a little in between each line being imaged. This makes reading a two-dimensional barcode problematic. Also, the image is blurred, because the object is moving during the imaging time. The blurring of the image is even more difficult to correct for.

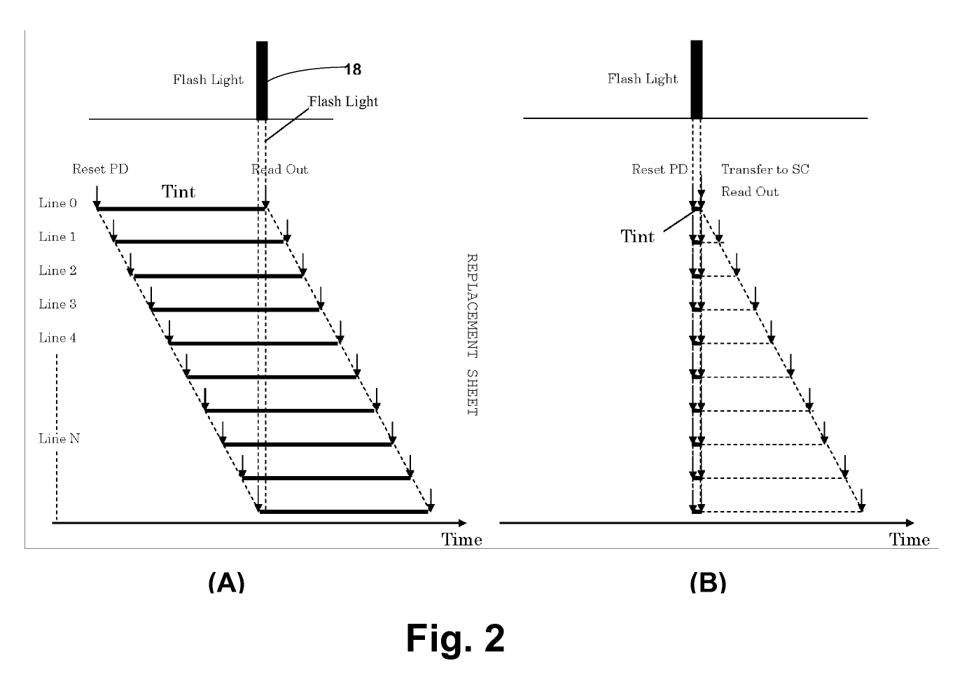

FIGS. 2(A) and 2(B) are timing charts illustrating the operation of a CMOS (rolling shutter) and a CCD (global shutter) imager, respectively, with flash illumination. It is well-known in photography that flash illumination can “stop motion”, allowing fixed images of moving objects. Since all the cells in a CCD imager are read out simultaneously, using flash illumination is a natural extension. As can be seen in FIG. 2(B), it is only a matter of assuring that the cells receive sufficient illumination during Tᵢₙₜ.

Referring to FIG. 2(A), however, it can be seen that each line of the CMOS imager receives a different amount of illumination before the flash occurs at 18. Proper exposure can be assured only if the flash controls the amount of light received by the imager. Accordingly it becomes necessary to use a flash which is much brighter than ambient light. Thus, one would not be inclined to use flash illumination with a CMOS imager, unless it was intended to use a very bright flash, typically 1000 times as intense as ambient light.

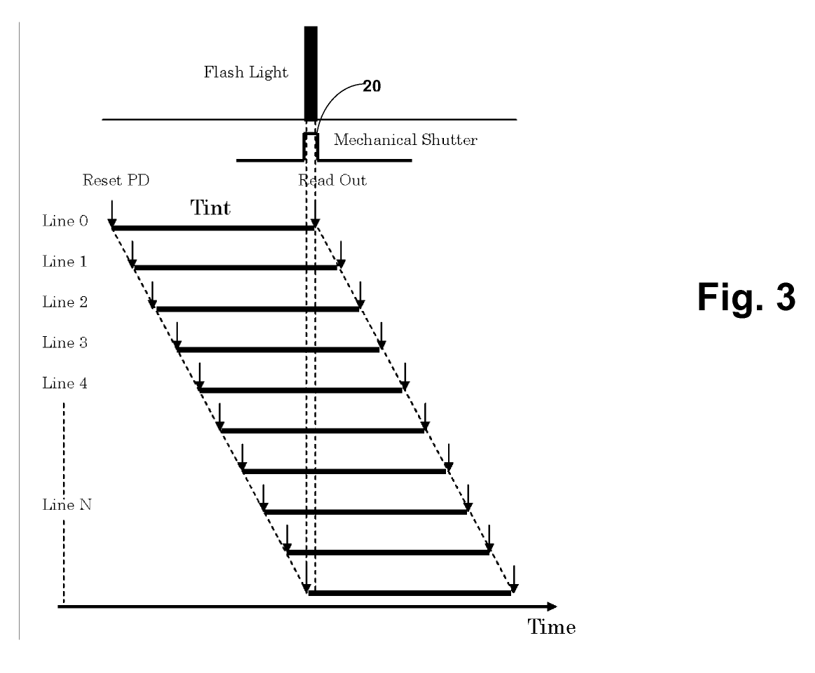

FIG. 3 is a timing chart illustrating the operation of a CMOS (rolling shutter) with addition of a physical shutter. In accordance with one aspect of the present invention, a physical shutter (not necessarily mechanical, as illustrated), is synchronized to open at the start of the flash illumination, preferably at a time after the reset of the last line and before the readout of the first line, as shown at 20 in FIG. 3. Preferably, the shutter is open for the entire duration of the flash. This permits the use of only the amount of illumination necessary to produce the required exposure, since each line also receives the same amount of ambient light, it receives the same amount of total exposure as every other line. As a result it becomes possible to use flash illumination which is comparable to or less than ambient light in intensity.

One exemplary manner in which to implement the physical shutter is to use a rotating disk or similar member with apertures so that there is periodically an opening for the light to impinge upon the sensor. In such an arrangement, the flash illumination and the image sensor must be synchronized to capture the light reflected during the time that each opening of the physical shutter permits the passage of light.

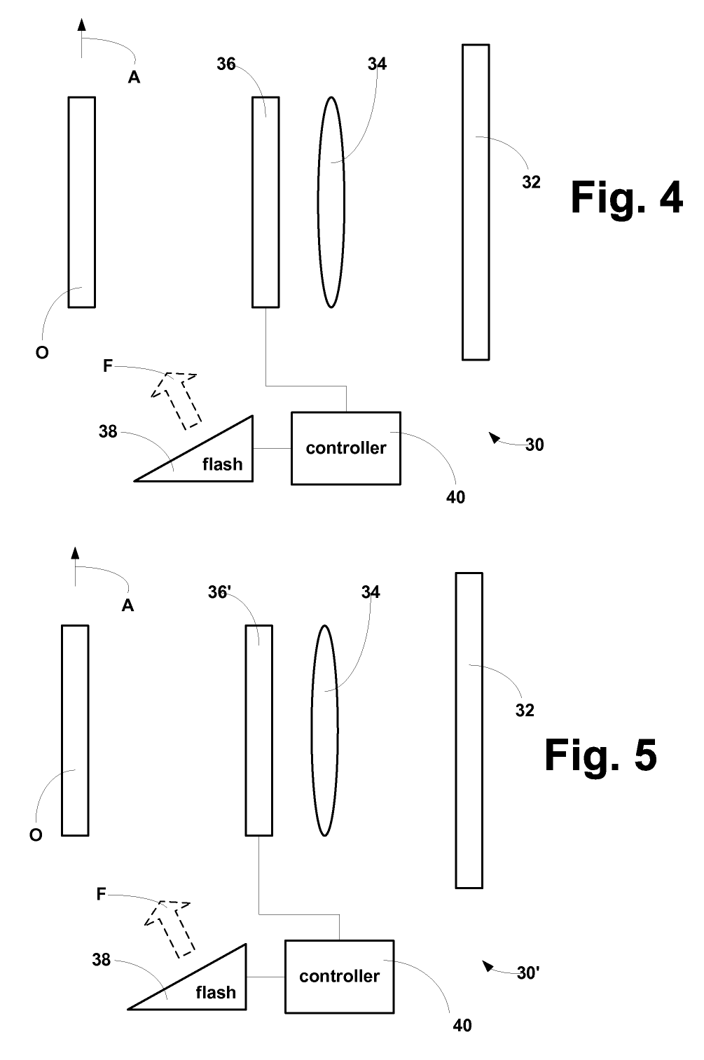

FIG. 4 is a functional block diagram illustrating a first embodiment 30 of an imaging system embodying the present invention. The system images an object O which is moving as indicated by the arrow A. Object O includes a code, such as a two-dimensional barcode, facing to right in FIG. 4, which is to be imaged on an imager or sensor array 32. Preferably, imager 32 is a CMOS imager. The image is formed on imager 32 through a lens 34, and a physical shutter 36, such as an electronic or mechanical shutter, is interposed between lens 34 and object O. objects oh was illuminated by a flashing device 38, which provides the flashing illumination F. A controller 40 controls flashing device 38 and shutter 36 so that the shutter opens coincidentally with the initiation of the flash illumination F. Preferably, controller 40 keeps shutter 36 open for the full duration of the flash illumination F. In this manner, the operation illustrated in FIG. 3 is achieved.

FIG. 5 is a functional block diagram illustrating a second embodiment 30′ of an imaging system embodying the present invention. System 30′ is identical to system 30 of FIG. 4, except that lens 36 is replaced by an optical mechanism 36′. Mechanism 36′ is controlled by controller 40 so as to focus the image of the object of 0 doing the flash F, but to provide a blurred focus in the absence of the flash F. mechanism 36′ may, for example, be an electronically controllable liquid crystal lens. Again, embodiment 30 prime achieves the operation illustrated in FIG. 3. It will be appreciated that both they shutter 36 and an adjustable focus mechanism 36′ could be provided in the same system.

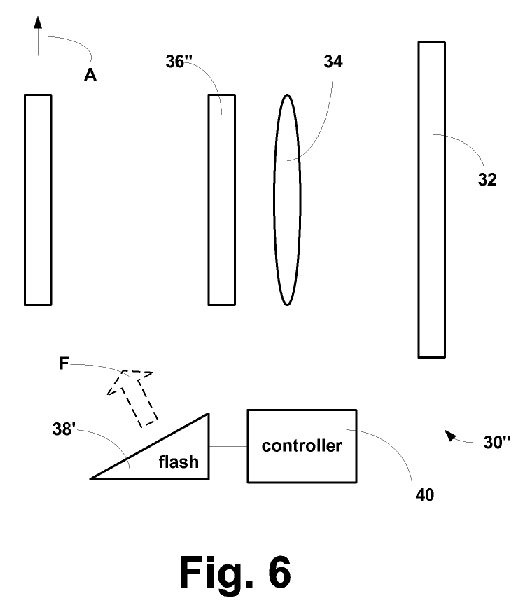

FIG. 6 is a functional block diagram illustrating a third embodiment 30″ of an imaging system embodying the present invention. In this embodiment, shutter 36 or optical mechanism 36′ is replaced by a lens 36″. In this embodiment, a flashing device 38″ is utilized which provides light in a predetermined frequency that is substantially different from ambient light. Lens 36″ is constructed so as to transmit the frequency of the flashing device 38′ and to block the frequencies contained in ambient light. As a result, imager 32 will receive only the image illuminated by flashing a light F.

It is also notable that when the ambient light is bright enough, the flash illumination may not be needed. The effective integration time can thus be set by changing the pulse width of the incident light, when the flash is used, or by changing the electronic shutter period of the sensor array. The system designer may choose either, or the system may include a light sensor that chooses which manner in which to control the effective integration time of the CMOS or other sensor, depending upon whether the ambient light is beyond a predetermined threshold or not.

Although preferred embodiments of the invention have been disclosed for illustrative purposes, those skilled in the art will appreciate that many additions, modifications, and substitutions are possible without departing from the scope and spirit of the invention as defined by the accompanying claims.

What is claimed:

1. A method for forming an image of a moving object on an electronic imager which incorporates a rolling electronic shutter, the imager having a sensing surface facing the object, the method comprising the steps of:
directing flash illumination at the object;
operating a shutter to initiate charge accumulation coincident with opening of said shutter, and terminating charge accumulation a predetermined time after opening said shutter, wherein the shutter is open for a sufficient time only for the ambient light and the flashing light, when combined, to impart sufficient power to image the moving object.

2. Operating the physical mechanism so as to be in the active state for approximately the full duration of the flash illumination.

3. The method of claim 1 or claim 2, wherein the physical mechanism is a physical shutter and the active state is the state of the shutter being open.

4. The method of claim 3, wherein the physical mechanism further comprises a lens having a focus which is controllable through automation interposed between the object and the imager, the active state of the lens being the lens focused on the object, and an inactive state being the lens out of focus.

5. The method of claim 4, wherein the lens is an electronically controllable liquid crystal lens.

6. The method of claim 1 or claim 2, wherein the physical mechanism is a lens having a focus which is controllable through automation, the active state being the lens focused on the object, and an inactive state being the lens out of focus.

7. The method of claim 6, wherein the lens is an electronically controllable liquid crystal lens.

8. The method of any preceding claim, wherein the flash illumination is provided at a frequency which is very different from ambient light, the method further comprising interposing between the object and the imager a filter which transmits the frequency of the flash illumination but does not provide any substantial transmission at the frequencies of ambient light.

9. The method of claim 1 wherein the physical mechanism is a rotating disk.

10. Apparatus for forming an image of a moving object on an electronic imager which incorporates a rolling electronic shutter, the imager having a sensing surface facing the object, comprising:
a source of flash illumination directed at the object, the illumination being no more intense than approximately that of ambient light;
a physical mechanism interposed between the object and the sensing surface, the physical mechanism having an active state; and
a controller constructed to cause the physical mechanism to go into its active state in coincidence with the initial occurrence of the flash illumination.

11. The apparatus of claim 10 wherein the controller is constructed to place the physical mechanism in its active state for approximately the full duration of the flash illumination.

12. The apparatus of claim 10 or claim 11, wherein the physical mechanism is a physical shutter and the active state is the state of the shutter being open.

13. The apparatus of claim 12, wherein the physical mechanism further comprises a lens having a focus which is controllable through automation, the lens interposed between the object and the imager, the active state of the lens being the lens focused on the object, and an inactive state being the lens out of focus.

14. The apparatus of claim 13, wherein the lens is an electronically controllable liquid crystal lens.

15. The apparatus of claim 10 or claim 11, wherein the physical mechanism is a lens having a focus which is controllable through automation, the active state being the lens focused on the object, and an inactive state being the lens out of focus.

16. The method of claim 15, wherein the lens is an electronically controllable liquid crystal lens.

17. The apparatus of any preceding claim, wherein the source of flash illumination is constructed to provide illumination at a frequency which is very different from ambient light, the apparatus further comprising a filter interposed between the object and the imager, the filter being constructed to transmit the frequency of the flash illumination but to provide no substantial transmission at the frequencies of ambient light.

18. An apparatus for taking an image of an object comprising a sensor array having an electronic shutter and an effective integration time, and a source of light having a pulse width, and wherein the effective integration time may be selectively set based upon either a period associated with said electronic shutter, or upon said pulse width.

19. The apparatus of claim 18 wherein the effective integration time is manually selectable.

20. The apparatus of claim 19 wherein the effective integration time is manually selectable.
